(19) United States
(12) Patent Application Publication
(10) Pub. No.: US 2024/0139066 A1
(43) Pub. Date: May 2, 2024

(54) SAUNA WITH INTRA-SLAT INFRARED HEATER ELEMENTS

(71) Applicants: Christopher Kiggins, Lahaina, HI (US); Martijn Steinrucken, Placerville, CA (US)

(72) Inventors: Christopher Kiggins, Lahaina, HI (US); Martijn Steinrucken, Placerville, CA (US)

(21) Appl. No.: 18/386,092

(22) Filed: Nov. 1, 2023

Related U.S. Application Data
(60) Provisional application No. 63/421,500, filed on Nov. 1, 2022.

(51) Int. Cl. A61H 33/06

(52) U.S. Cl. CPC A61H 33/063; A61H 2033/061; A61H 2201/0207

(57) ABSTRACT

A sauna includes a plurality of side walls, a floor, and a ceiling. A heat emitter assembly is coupled to at least one of the plurality of side walls, the floor, or the ceiling. A buffer wall is positioned in front of the heat emitter assembly, wherein at least a portion of the heat emitter assembly is exposed through an opening in the buffer wall. In some embodiments, the heater emitter assembly comprises a plurality of carbon, fiber, ceramic, or a combination of carbon-ceramic, infra-red emitter units coupled to at least one of the plurality of side walls, the floor, or the ceiling. A buffer wall comprising a plurality of wooden slats, is positioned proximate the infra-red emitter units. The wooden slats and the infra-red emitter units are arranged in an alternating order, exposing the infra-red emitter units between openings defined by adjacent wooden slats in the buffer wall.

### CROSS-REFERENCE TO RELATED APPLICATIONS

This application claims benefit under 35 U.S.C. § 119(e) of U.S. Provisional Application having Ser. No. 63/421,500 filed Nov. 1, 2022, which is hereby incorporated by reference herein in its entirety.

### BACKGROUND

The embodiments described herein relate generally to sauna systems, and more particularly, to a sauna with intra-slat infrared heater elements.

Infrared saunas exist to increase core body temperature in a small, enclosed space by using carbon, halogen or ceramic panels that have electricity run through them to generate heat. Before the subject disclosure, the panels do not heat the entire wall of a space; just a portion of it. Consequently, the heating in a sauna can be inconsistent and localized to the location of the panels. Because of this, there is a need for an improved heating structure in sauna systems that allows for the entire wall of the sauna to be one big heater, which will increase infrared efficiency.

### SUMMARY

In one embodiment of the subject disclosure, a sauna is disclosed. The sauna includes a plurality of side walls, a floor, and a ceiling. A heat emitter assembly is coupled to at least one of the plurality of side walls, the floor, or the ceiling. A buffer wall is positioned in front of the heat emitter assembly, wherein at least a portion of the heat emitter assembly is exposed through an opening in the buffer wall.

In another embodiment, a sauna includes a plurality of side walls, a floor, and a ceiling. A plurality of carbon, fiber, ceramic, or a combination of carbon-ceramic, infra-red emitter units coupled to at least one of the plurality of side walls, the floor, or the ceiling. A buffer wall comprising a plurality of wooden slats, is positioned proximate the plurality of carbon, fiber, ceramic, or a combination of carbon-ceramic, infra-red emitter units. The wooden slats and the carbon, fiber, ceramic, or a combination of carbon-ceramic, infra-red emitter units are arranged in an alternating order, exposing the carbon, fiber, ceramic, or a combination of carbon-ceramic, infra-red emitter units between openings defined by adjacent wooden slats in the buffer wall.

### BRIEF DESCRIPTION OF THE FIGURES

The detailed description of some embodiments of the invention is made below with reference to the accompanying figures, wherein like numerals represent corresponding parts of the figures.

FIG. 1 a partial, internal end view of a sauna system, according to embodiments of the subject technology.

FIG. 2 is a cross-sectional front view of a heating wall in the sauna system of FIG. 1, consistent with an embodiment.

FIG. 3 is a partial cross-sectional side view of the heating wall in the sauna system of FIG. 1, consistent with an embodiment.

FIG. 4 is a cross-sectional top view of a floorplan of the sauna system of FIG. 1, consistent with an embodiment.

FIG. 5 is a cross-sectional view facing a back wall of the sauna system of FIG. 1, consistent with an embodiment.

FIG. 6 is a cross-sectional front view of the sauna system of FIG. 1, highlighting a section of the back wall that includes a heating wall section positioned in the back wall, consistent with embodiments.

FIG. 7 is a cross-sectional end view of a sauna system incorporating a regulatory compliant bench according to another embodiment.

FIG. 8 is an end view of a sauna system incorporating a high and low benches according to another embodiment.

FIG. 9 is a partial perspective view of wiring coupled to a heat emitter wall in a sauna system, consistent with embodiments disclosed herein.

FIG. 10 is a partial perspective view of a partially assembled heat emitter wall in a sauna system, consistent with embodiments disclosed herein.

FIG. 11 is an isolated view of a heat emitter assembly, consistent with embodiments disclosed herein.

FIG. 11A is an enlarged view of an end of the heat emitter assembly of FIG. 11.

FIG. 11B is an enlarged view of a temperature limiter on the heat emitter assembly of FIG. 11.

FIG. 12 is an exploded view of the heat emitter assembly of FIG. 11 without certain electrical components.

FIG. 13 is an isolated perspective view of a customizable wall of the sauna system of FIG. 1.

### DETAILED DESCRIPTION OF CERTAIN EMBODIMENTS

Referring to the Figures in general, embodiments of the disclosed invention provide a sauna that includes an infra-red (IR) heating element(s) placed on one or more of the interior walls where at least some part of the heating element is exposed through a buffer wall. It will be understood that in some views, not every wall is shown. The examples shown throughout the figures show one embodiment of a sauna that illustrates the use of a plurality of IR emitter panels recessed behind, and in between, a plurality of wooden slats so that the IR emitter panels alternate in series with the wooden slats. As will be appreciated by this embodiment and the additional broader or more specific embodiments described below, the IR emitter panels are disposed to diffuse heat more evenly into the sauna room safely from behind the wood slats. The wooden slats may be heated by the IR emitter panels so that a pleasing wooden smell is generated in addition to protection from inadvertent contact with the heater elements.

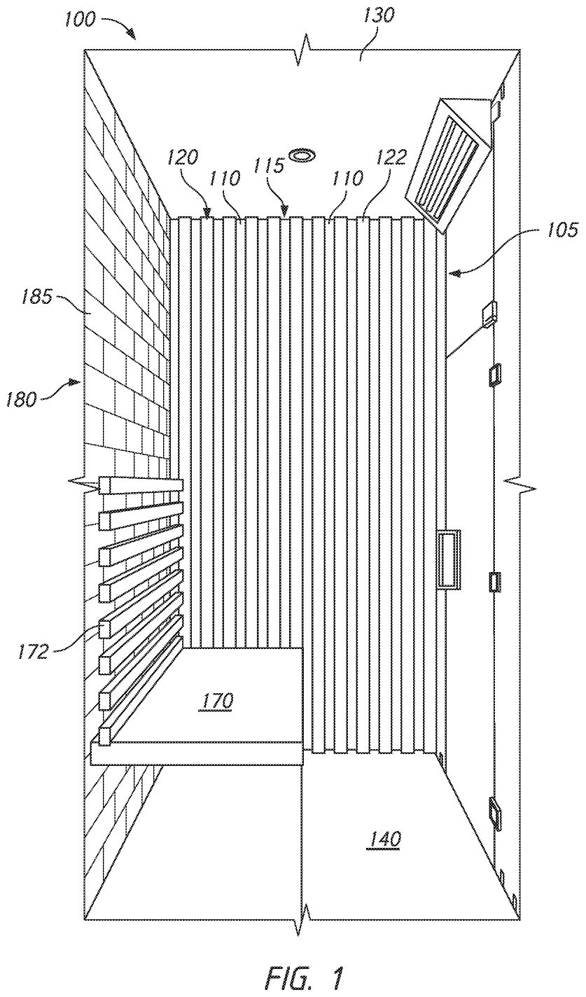

FIG. 1 shows an interior of a sauna system according to an embodiment. At a high level, the sauna system 100 includes a heating wall 105 that emits an electrified form of heat. The heating wall 105 may be positioned on one or more of any of the end walls, front or back walls, ceiling 130, or floor 140. In FIG. 1, the example shows the heating wall 105 positioned on the right side end wall (with the perspective shown as looking in from the left side end wall, with the front wall on the right and the back wall on the left.

The heating wall 105 may include a heating assembly 115 and a buffer wall 120 positioned proximate the heating assembly 115. At least a portion of the heating assembly 115 is exposed through openings in the buffer wall 120. The heating assembly 115 and/or the buffer wall 120 may comprise different form factors. For example, the buffer wall 120 may be mostly a solid wall with elongated openings. In one embodiment, the heating assembly 115 may be a single heater panel configured to emit infra-red radiation. In embodiments where the buffer wall 120 is positioned in front of the heating assembly 115, sections of the heating element(s) in the heating assembly 115 will be exposed by the openings in the buffer wall 120, allowing radiation to emit from the heating wall 105.

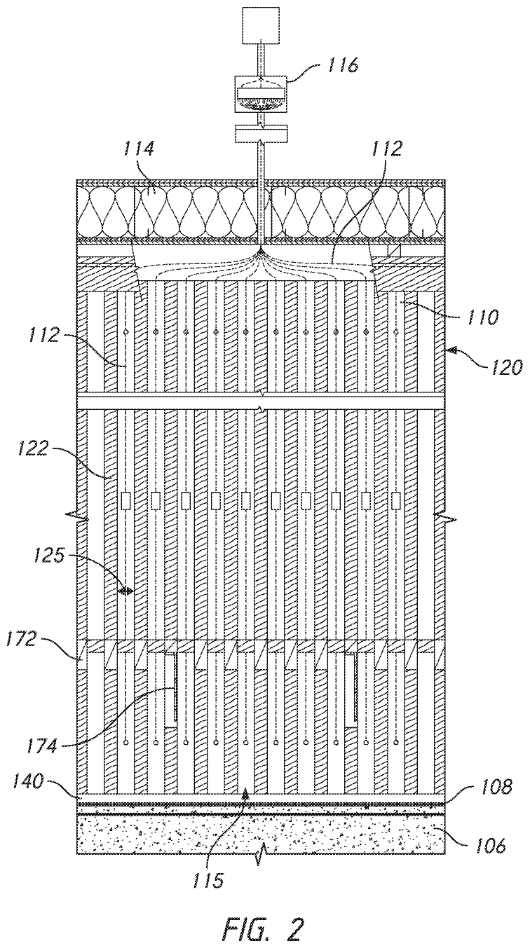

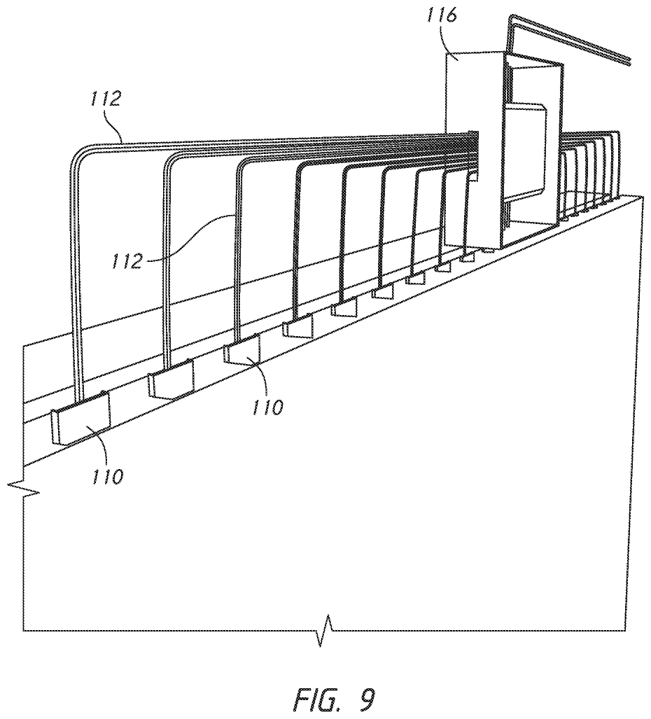

In the example shown in the figures, the heating assembly 115 may comprise a plurality of heater panels 110 (sometimes referred to earlier as an IR emitter panel). The heating wall 105 and/or the heater panels 110 may comprise carbon, fiber, ceramic, or a combination of carbon-ceramic heater panels. The buffer wall 120 comprises a plurality of slats 122. In some embodiments, the buffer wall 120 may be wholly or partially wooden (for example, cedar or other wood) or made out of other materials including for example salt, ceramic, composite, rock, etc. Referring still to FIG. 1 but concurrently now with FIGS. 2 and 9, an embodiment using a plurality of heater panels 110 is shown. The slats 122 of buffer wall 120 may be arranged side by side with the long axis positioned vertically against the heating wall 105. The plurality of heater panels 110 may be arranged so that an individual heater panel 110 is positioned between two adjacent slats 122. The heater panels 110 may be arranged so that their long axis is parallel with the long axis of the slats, whether vertical, horizontal, or diagonal. However, in some embodiments, the slats 122 may be arranged perpendicular (crisscrossed) with the heater panels 110 as long as the heater panels 110 have some opening through the slats 122 to emit heat through. In some embodiments, individual heater panels 110 are behind two adjacent slats 122 with the center of the heater panel 110 exposed through an opening 125 (Seefor example, FIG. 2), defined by the inner edges of adjacent slats 122. The heater panel 110 may be fully or partially exposed in the opening 125. In some embodiments, the heater panel 110 is juxtaposed with adjacent slats 122 so that the heater panel 110 is on the same plane as the slats 122, within opening 125. As may be appreciated, in any of the described orientations, the heating elements, diffuse heat through the slats 122 providing an expanded area of heat zones in comparison to the localized heated regions of conventional sauna systems.

In some embodiments, the heater panels 110 are positioned vertically and extend from the ceiling 130 down to the floor 140. However, in some embodiments, the ends of heating elements (heater panels 110) may be less than the height of the sauna room. When positioned in a vertical orientation, wiring 112 (FIGS. 2 and 9) may be run along the ceiling 130 or floor 140 connecting a power source in a control module 116 to the ends of respective heating elements.

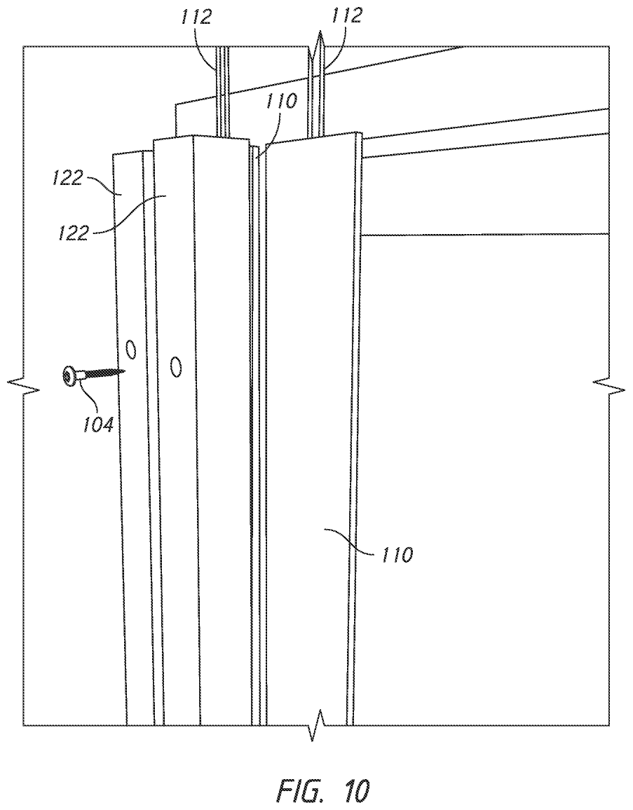

FIG. 10 shows an embodiment that comprises the slats 122 of the buffer wall 120 secured to a support wall by a fastener 104. The slats 122 are fastened in the gaps between adjacent heater panels 110 to the support wall. The slat material buffers the sauna interior from direct heat while diffusing heat in an area effect around the slat.

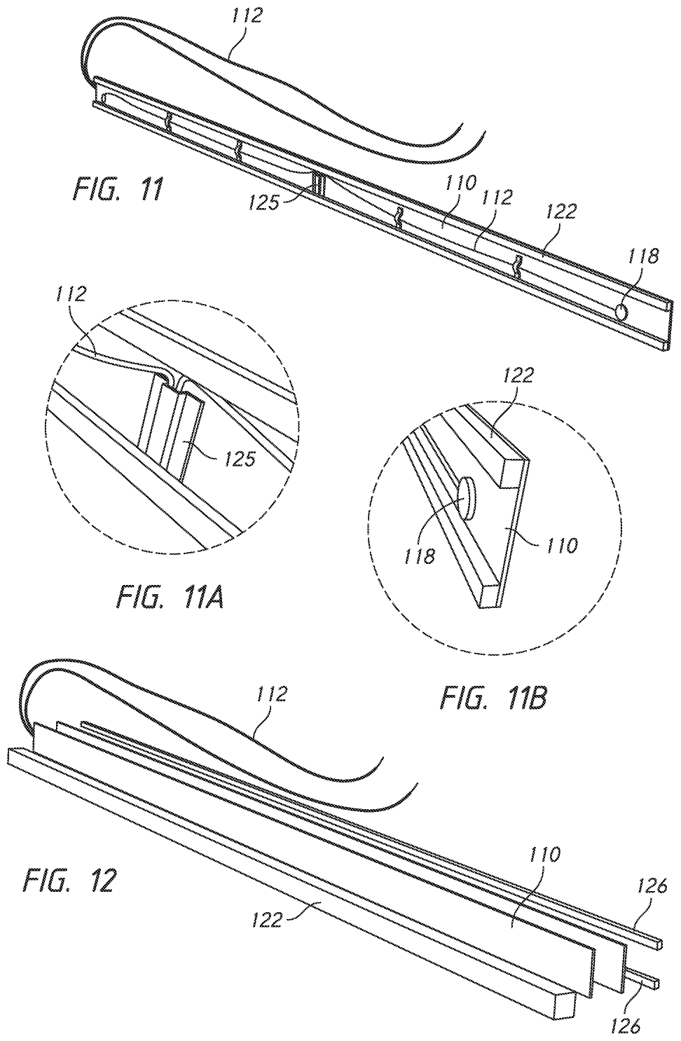

FIGS. 11, 11A, 11B, and 12 show a detailed view of a heating element assembly. Wiring 112 may be routed down the length of a heater panel 110, The current in the wiring 112 is converted energy by the surrounding panel material which may be for example, an infra-red output. Some embodiments include a temperature limiter 128. The temperature limiter 128 may limit the amount of current, and thus heat output, from the heater panels 110. A terminator 118 provides an entry for the wring 112 into the heater panels 110. The views in these figures show only partial views of the slats from buffer wall 120. Some embodiments include an insulation barrier 124 and/or insulation strips 126 coupled to the heater panels 110, protecting the outer walls from the heat generated by the heating elements.

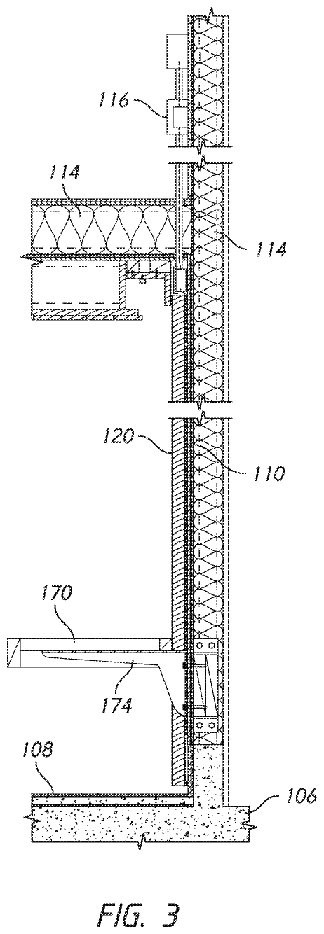

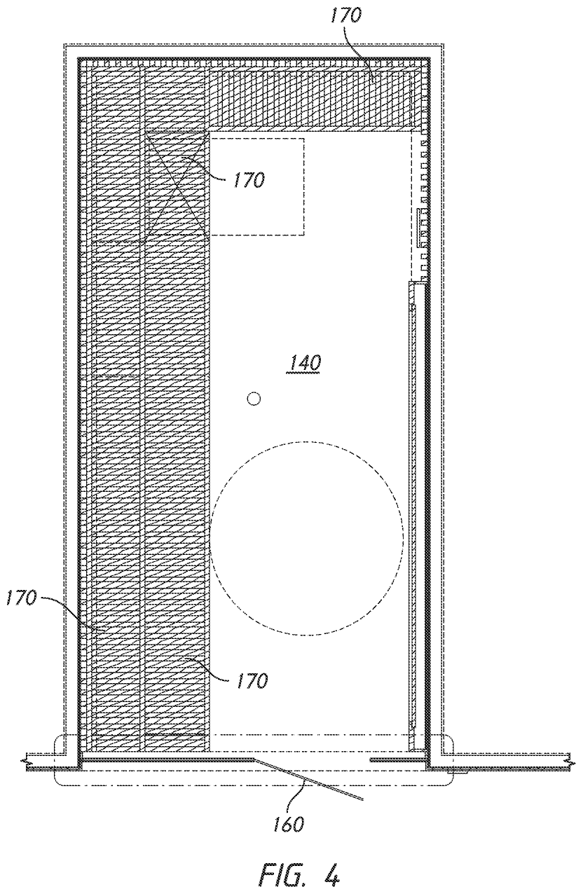

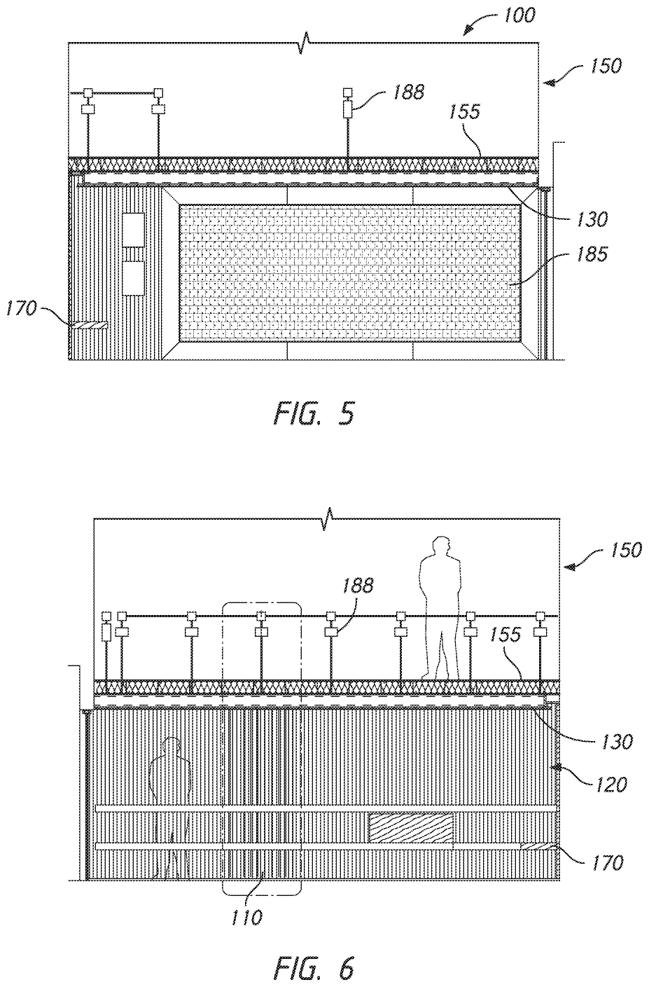

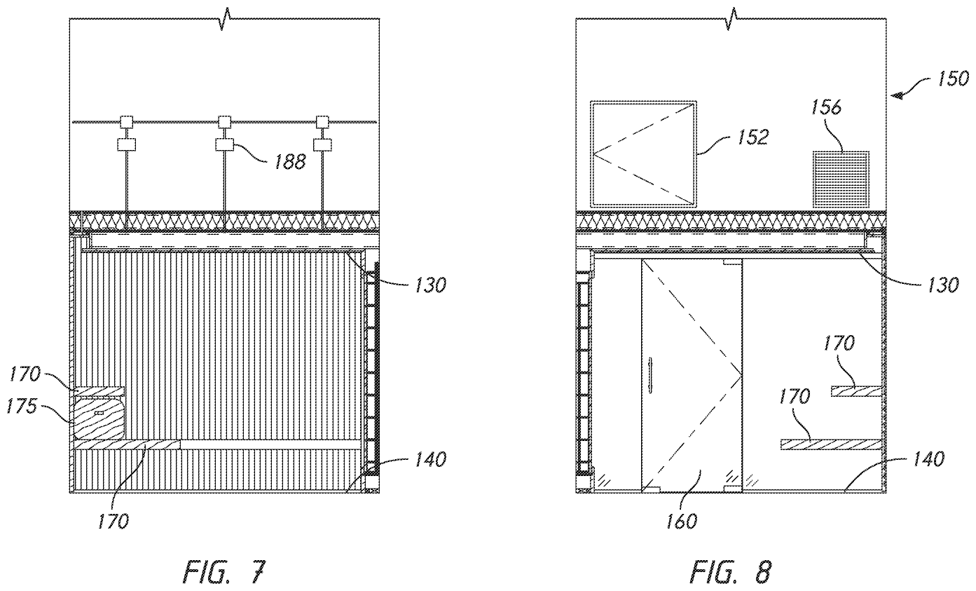

Referring back to FIG. 1 along with FIGS. 2-8, the sauna system 100 includes additional features shown. Embodiments may generally include one or more benches 170. FIG. 4 shows an example floorplan where multiple benches 170 may be located. As shown in FIG. 1, the style of bench 170 may include supportive rest slats 172 that are spaced apart on the back wall, above the seat of bench 170. The bench 170 may be floating, supported by a bracket 174 (seen in FIGS. 2 and 3). FIG. 7 shows a bench 170 that may cooperate with a regulatory compliant back support 175.

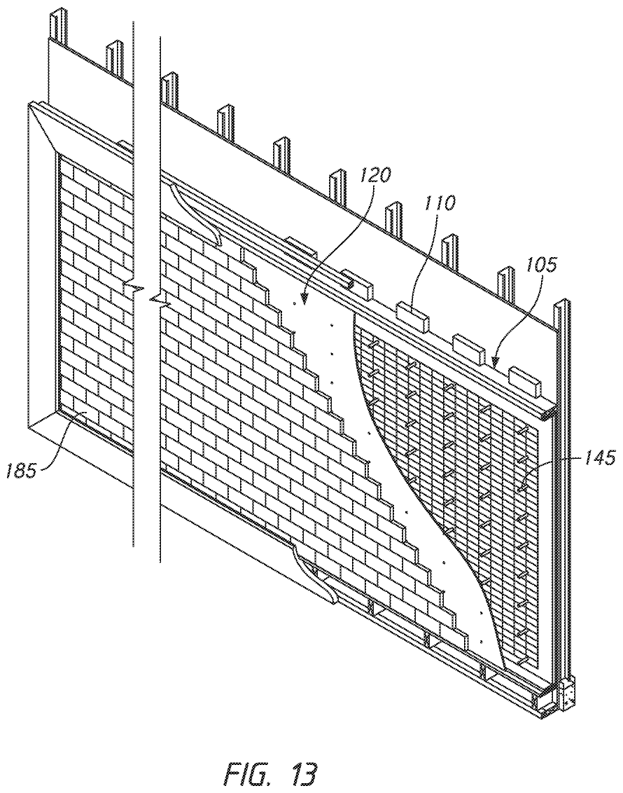

Some embodiments may include a customizable wall 180. The customizable wall 180 may include the heating wall 105 behind it. (See for example, FIG. 13.) The customizable wall 180 may include a functional or aesthetic layer 185. For example, the layer 185 may be a wall of bricks comprising rock salt. Some embodiments may include an array of lights 145 (for example, L.E.D.s positioned behind the layer 185. When heated up, the salt may emit visually pleasing light and/or a therapeutic airborne property. Some of the light may be generated by the lights 145. The heat from the heating wall 105 behind the layer 185 may radiate through the supportive rest slats 172 of bench 170 shown in FIG. 1 providing buffered heat to the back of users.

Referring to FIGS. 3 and 5-8, some embodiments include an access area 150 above the ceiling 130. Insulation 114 may be placed in between the ceiling 130 and an access platform 155 in the access area 150. Technicians may use the access area 150 to access for example, electrical components such as lighting driver modules 188 that power lighting elements (lights 145) behind the layer 185. Some embodiments include an access panel 152 that provides access to the electrical components and control items in the access area 150. A vent 156 may provide airflow in or out of the access area 150.

Those of skill in the art would appreciate that various components may be arranged differently (e.g., arranged in a different order, or partitioned in a different way) all without departing from the scope of the subject technology.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

Terms such as “top,” “bottom,” “front,” “rear,” “above,” “below” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference. Similarly, an item disposed above another item may be located above or below the other item along a vertical, horizontal or diagonal direction; and an item disposed below another item may be located below or above the other item along a vertical, horizontal or diagonal direction.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A sauna, comprising:
a plurality of side walls, a floor, and a ceiling;
a heat emitter assembly coupled to at least one of the plurality of side walls, the floor, or the ceiling; and
a buffer wall positioned in front of the heat emitter assembly, wherein at least a portion of the heat emitter assembly is exposed through an opening in the buffer wall.

2. The sauna of claim 1, wherein the heat emitter assembly includes a plurality of infra-red emitter elements.

3. The sauna of claim 2, wherein the buffer wall comprises a plurality of slats.

4. The sauna of claim 3, wherein the plurality of infra-red emitter elements are positioned respectively in repeated openings between adjacent slats in the buffer wall.

5. The sauna of claim 4, wherein the plurality of infra-red emitter elements and the slats are arranged vertically between the floor and the ceiling.

6. The sauna of claim 4, wherein the plurality of infra-red emitter elements and the slats are arranged horizontally.

7. The sauna of claim 2, wherein the buffer wall comprises a plurality of elongated openings.

8. The sauna of claim 1, wherein the buffer wall comprises a wood material.

9. The sauna of claim 1, wherein the heat emitter assembly is a solid wall extending between two or more adjacent openings in the buffer wall.

10. A sauna, comprising:
a plurality of side walls, a floor, and a ceiling;
a plurality of carbon, fiber, ceramic, or a combination of carbon-ceramic, infra-red emitter units coupled to at least one of the plurality of side walls, the floor, or the ceiling; and
a buffer wall comprising a plurality of wooden slats, positioned proximate the plurality of carbon, fiber, ceramic, or a combination of carbon-ceramic, infra-red emitter units, wherein the wooden slats and the carbon, fiber, ceramic, or a combination of carbon-ceramic, infra-red emitter units are arranged in an alternating order, exposing the carbon, fiber, ceramic, or a combination of carbon-ceramic, infra-red emitter units between openings defined by adjacent wooden slats in the buffer wall.

11. The sauna of claim 10, wherein the plurality of wooden slats are positioned in front of the plurality of carbon, fiber, ceramic, or a combination of carbon-ceramic, infra-red emitter units.

12. The sauna of claim 10, wherein the plurality of wooden slats are positioned juxtaposed with the plurality of carbon, fiber, ceramic, or a combination of carbon-ceramic, infra-red emitter units.

13. The sauna of claim 10, further comprising a control unit, wherein an output of the plurality of carbon, fiber, ceramic, or a combination of carbon-ceramic, infra-red emitter units is controllable from the control unit.

14. The sauna of claim 10, further comprising a layer of rock salt positioned in front of the plurality of carbon, fiber, ceramic, or a combination of carbon-ceramic, infra-red emitter units.
